(19) United States
(12) Patent Application Publication
(10) Pub. No.: US 2012/0268288 A1
(43) Pub. Date: Oct. 25, 2012

(54) ARCNET USE IN DOWNHOLE EQUIPMENT

(75) Inventors: Daniel M. Cousin, Humble, TX (US); Paul A. Lowson, Houston, TX (US); David L. Jacobs, Houston, TX (US); Randall Perrin, Grawn, MI (US); Edwin C. Scholl, Traverse City, MI (US); Jerry Miller, Traverse City, MI (US); Dean M. Vieau, Traverse City, MI (US)

(73) Assignee: BAKER HUGHES INCORPORATED, Houston, TX (US)

(21) Appl. No.: 13/449,523

(22) Filed: Apr. 18, 2012

Related U.S. Application Data
(60) Provisional application No. 61/477,965, filed on Apr. 21, 2011.

(51) Int. Cl. G01V 3/12

(52) U.S. Cl. 340/854.7; 340/853.1; 340/855.8

(57) ABSTRACT

An apparatus and method for delivering communication and/or power downhole. The apparatus may include an information network configured to use a multi-drop deterministic protocol. The method may include delivering information over the information network. The method may include delivering power over the information network.

### CROSS-REFERENCE TO RELATED APPLICATION

This application claims priority from U.S. Provisional Patent Application Ser. No. 61/477,965, filed on 21 Apr. 2011.

### FIELD OF THE DISCLOSURE

This disclosure generally relates to communication and power for downhole tools.

### BACKGROUND OF THE DISCLOSURE

As more advanced well tools are used for exploration and production of hydrocarbons, the importance of collecting downhole information and providing power to downhole well tools increases. Communication of information and power, separately or together, to well tools from the surface or other downhole devices (including other well tools) may be limited by borehole dimensions and distance. Other limits may be presented by borehole environmental conditions, including temperature, pressure, changes in temperature, changes in pressure, and corrosivity.

### SUMMARY OF THE DISCLOSURE

In aspects, this disclosure generally relates to communication and power for downhole tools.

One embodiment according to the present disclosure includes an apparatus for communicating in a borehole, comprising: a plurality of well tools configured to be disposed in the borehole; a communication interface associated with each of the plurality of well tools, each communication interface being configured to use a multi-drop deterministic protocol; and a communication bus in communication with the communication interfaces.

Another embodiment according to the present disclosure includes a method for communication in a borehole, comprising: delivering information over an information network to at least one of a plurality of well tools disposed downhole, the information network using a multi-drop deterministic protocol.

Examples of certain features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of a downhole assembly in a borehole along a wireline according to one embodiment of the present disclosure;

FIG. 2 shows a schematic of the downhole assembly according to another embodiment of the present disclosure;

FIG. 3 shows a circuit diagram of the downhole assembly according to another embodiment of the present disclosure;

FIG. 4 shows a flow chart for a method for delivering information according to another embodiment of the present disclosure;

FIG. 5 shows a flow chart of a method for delivering power according to one embodiment of the present disclosure; and

FIG. 6 shows a schematic of a downhole assembly in a borehole on a drill string according to one embodiment of the present disclosure.

### DETAILED DESCRIPTION

This disclosure generally relates to communication and power for downhole tools. In one aspect, this disclosure relates delivering communication from the surface or a well tool to another well tool over an information network configured to use a multi-drop deterministic protocol. In another aspect, this disclosure relates to delivering power to operate at least one of a plurality of well tools over an information network configured to use a multi-drop deterministic protocol. Non-limiting embodiments of devices and methods for delivering information and/or power are described below.

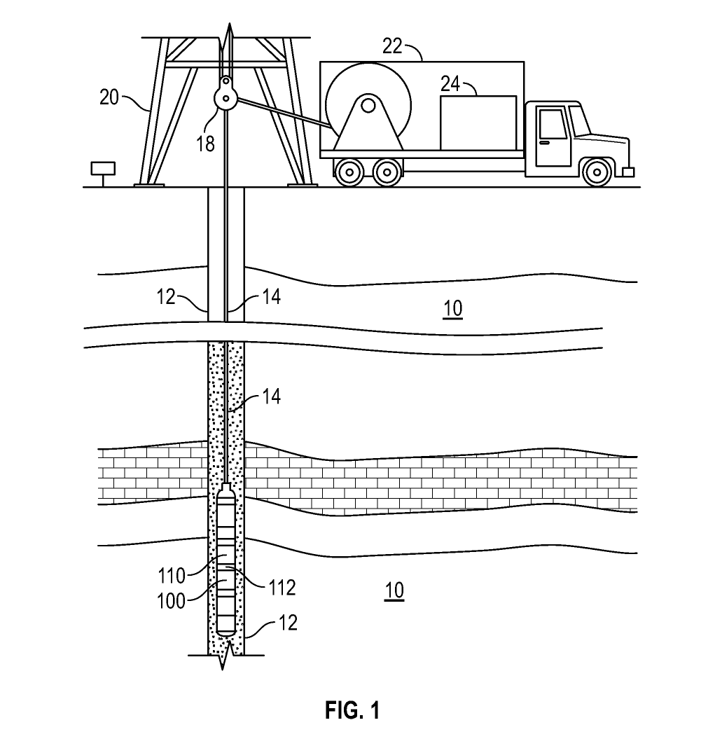

Referring initially to FIG. 1, there is schematically represented a cross-section of a subterranean formation 10 in which is drilled a borehole 12. Suspended within the borehole 12 at the bottom end of a carrier 14, such as a wireline, is a downhole assembly 100. In some embodiments, the carrier 14 may be rigid, such as a coiled tube, casing, liners, drill pipe, etc. In other embodiments, the carrier 14 may be non-rigid, such as wirelines, wireline sondes, slicklines, slickline sondes, e-lines, drop tools, self-propelled tractors, etc. The term “carrier” as used herein means any device, device component, combination of devices, media and/or member that may be used to convey, house, support, or otherwise facilitate the use of another device, device component, combination of devices, media and/or member. The carrier 14 may be carried over a pulley 18 supported by a derrick 20. Wireline deployment and retrieval is performed by a powered winch carried by a service truck 22, for example. A control panel 24 interconnected to the downhole assembly 100 through the carrier 14 by conventional means controls transmission of electrical power, data/command signals, and also provides control over operation of the components in the downhole assembly 100. The data may be transmitted in analog or digital form.

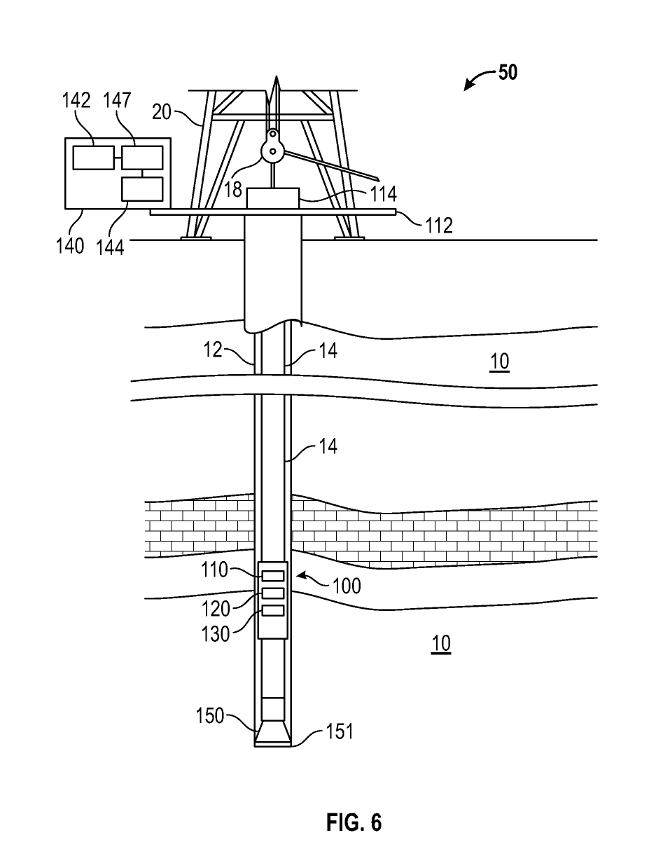

Downhole assembly 100 may include a first well tool 110, a second well tool 120, and a third well tool 130. Any number of well tools may exist as part of the downhole assembly 100. The term “well tool” relates to any devices configured to operate in a borehole, including, but not limited to, sensors, energy sources, measurement devices, and other devices discussed in connection with FIG. 6.

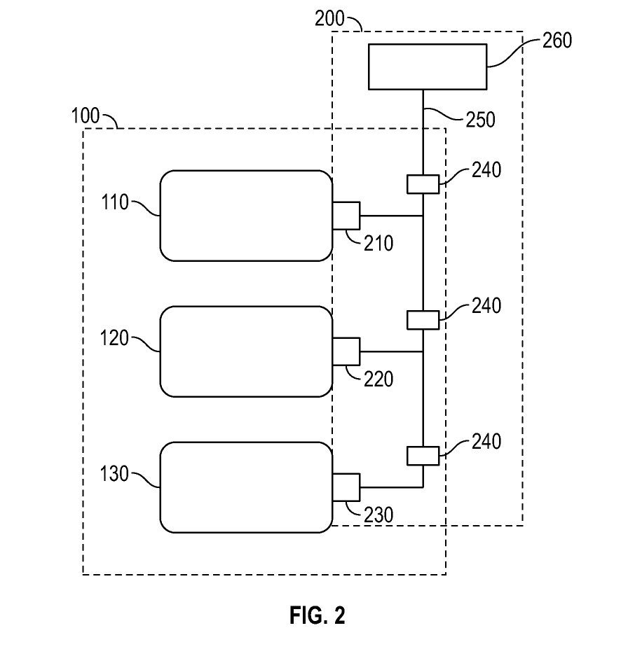

Well tools 110, 120, 130 may be disposed in the borehole 12 where surface communication and power may not be accessible. Operation of the well tools 110, 120, 130 in the borehole 12 may require access to an information network 200 (see FIG. 2) configured to deliver information and/or power to the well tools 110, 120, 130 from the surface. In some embodiments, the information network 200 may be configured to deliver information from one well tool to one or more other well tools. In some embodiments, the information network 200 may be configured to deliver power to the well tools 110, 120, 130 from a downhole source. Non-limiting embodiments of the information network are described below.

FIG. 2 shows a schematic of an information network 200 that may be used in the downhole assembly 100 according to one embodiment of the present disclosure. The downhole assembly 100 may include one or more well tools 110, 120, 130, which have been previously discussed, in communication with information network 200. Information network 200 may include communication interfaces 210, 220, 230 and communication bus 250. Some of the communication interfaces may interface the well tools 110, 120, 130 with the information network 200. The communication interface 210, 220, 230 may include a machine logic device, such as, but not limited to, one or more of: i) a processor, ii) a field-programmable gate array (FPGA), iii) a complex programmable logic device (CPLD), iv) a programmable array logic (PAL) device, v) an application-specific integrated circuit (ASIC), and vi) a discrete digital logic circuit. The information network 200 may include a control module 260. The control module 260 may be configured to control the flow of information and/or power on the information network 200. The control module 260 may be configured to control the flow of information and/or power from the surface or other sources outside of the information network 200 into the information network 200. The information network 200 may be configured to deliver information using at least one of: i) electrical signals, ii) electromagnetic signals, and iii) optical pulses. The control module 260 may be disposed downhole or at the surface.

The communication interfaces 210, 220, 230 may be configured to use a multi-drop deterministic protocol for delivering information between the well tools 110, 120, 130 and the communication bus 250. Herein, the term “multi-drop” refers to the characteristic of a protocol to allow one or more nodes (such as a well tool or surface controller) of a plurality of nodes on a network to be attached to the network while maintaining network connectivity for any remaining nodes. Herein, the term “deterministic” refers to the characteristic of a protocol to have communication time allotments defined for each note, such that nodes do not compete for allotted time or suffer message collisions. One non-limiting example of a multi-drop deterministic protocol is ARCNET. In some embodiments, the multi-drop deterministic protocol may use token-passing embedded in the communication interfaces 210, 220, 230. In some embodiments, the multi-drop deterministic protocol may be configured to use a message as small as one byte in length.

The communication bus 250 may provide communication between one or more of the well tools 110, 120, 130 and one or more other well tools 110, 120, 130 and/or control module 260. The communication bus 250 may be configured for carrying signals and may be formed, at least in part, of at least one of: i) at least one conductor, ii) a twisted pair, iii) a coaxial cable, and iv) a fiber optic link. The communication bus 250 may be divided into segments by connectors 240 that are configured to allow passage of signals along the communication bus 250 across physical barriers (bulkheads, etc.). The connectors 240 may be configured to conduct signals and to prevent the flow of fluid from one well tool to another. The connectors 240 may be selected to reduce interface reflection that may result in signal attenuation along the communication bus 250. The connectors 240 may be configured for operation at the temperatures and pressures found in a downhole environment (greater than 70 degrees C. and greater than 1000 PSI).

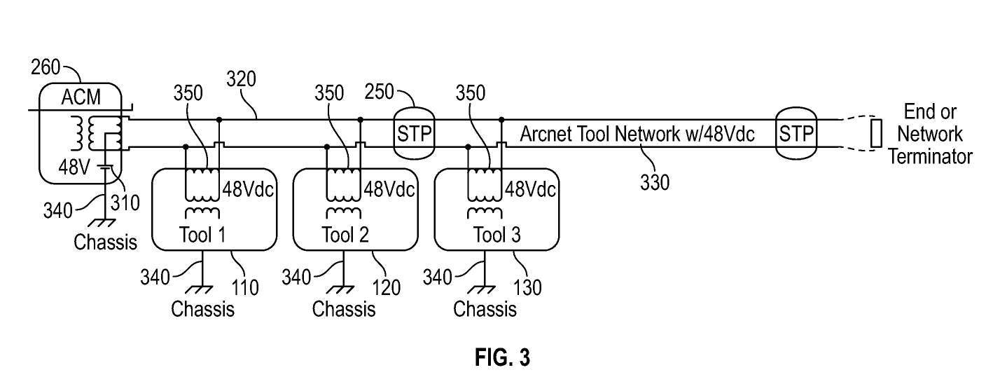

FIG. 3 shows a circuit diagram of an information network 200 configured to, in addition to information, deliver power to well tools 110, 120, 130 over the communication bus 250 of the downhole assembly 100 according to one embodiment of the present disclosure. Power may be supplied to well tools 110, 120, 130 from a power supply 310 within control module 260. In this non-limiting embodiment, the power supply 310 is shown as a battery symbol, which is connected to the center tap of a transformer. The power supply output of 48 volts is illustrative and exemplary only, as any suitable output voltage may be used based on desire operation. The power supply 310 may supply power to at least one well tool 110, 120, 130 over the information network 200. The power supply 310 may supply power to well tools 110, 120, 130 over a conductor of the communication bus 250. The communication bus 250 may include two conductors 320, 330 configured for information transmission. The information transmission signal may be floating with respect to a DC ground. The power from the power supply 310 may be common to both conductors 320, 330. The housing 340 of the downhole assembly 100 may serve as the power return to form a complete power circuit. In some embodiments, power from the power supply 310 may be supplied to the well tools 110, 120, 130 over a wire (not shown) separate from the two conductors 320, 330. In some embodiments, the information network 200 may include at least one separator 350 configured to at least partly separate a common mode (such as a DC signal on the two conductors 320, 330) from a differential mode (such as digital communications transmitted on the two conductors 320, 330) between at least one of the plurality of well tools 110, 120, 130 and the information network 200. In some embodiments, separation may involve attenuating one signal of two or more signals to a larger degree than another signal of the two or more signals. The degree of attenuation may be selected based on the application and knowledge of one of skill in the art. In some embodiments, the separator 350 may include one or more of: i) an inductor, ii) a transformer primary, iii) a resistor, and iv) a solid state circuit. In some embodiments, the separator 350 may cause at least one of the nodes 110, 120, 130 to present a high impedance to high frequency signals while presenting a low impedance to low frequency signals. In some embodiments, the common mode may include a high frequency signal on each of the two conductors 320, 330.

In some embodiments, a multi-drop deterministic protocol may be used on a point-to-point network. For example, a bi-directional buffer (not shown) may be located within each of plurality of nodes with the nodes arranged in series. The buffers may be configured to be transparent to communications and/or power delivered to nodes along the point-to-point network. In some embodiments, the buffers may be part of the communications interfaces 210, 220, 230.

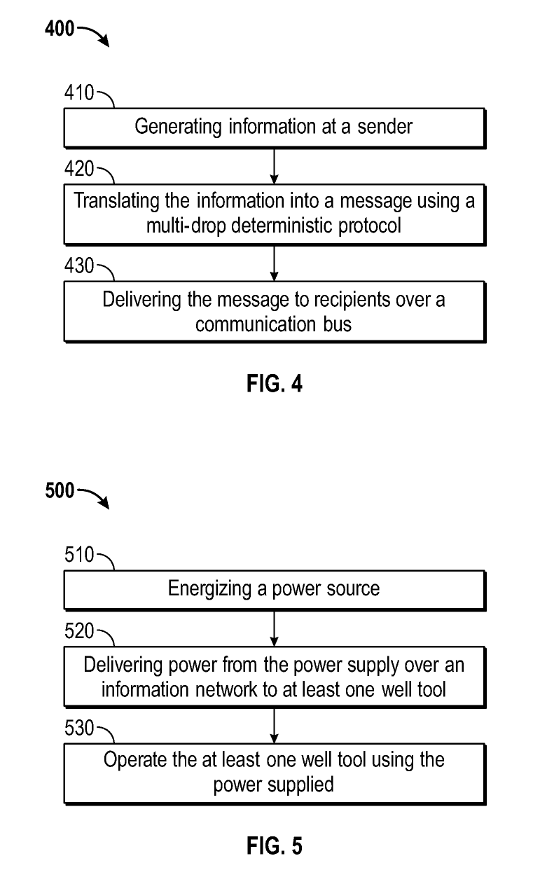

FIG. 4 shows a flow chart of a method 400 according to one embodiment of the present disclosure. In step 410, information may be generated by sender (a well tool 110, 120, 130 or the control module 260). At least one of the well tools 110, 120, 130 and/or the control module 260 may be located downhole. The information may include, but is not limited to, one or more of: i) a signal indicative of at least one earth formation property, ii) a signal indicative of at least one property of at least one well tool, and iii) an instruction for one or more well tools. In step 420, the information may be translated into a message by a communication interface 210, 220, 230 using a multi-drop deterministic protocol. In step 430, the message may be delivered to a recipient (one or more well tools and/or the control module 260) over communication bus 250. In some embodiments, the communication bus 250 may also be configured to deliver power to at least one of the well tools 110, 120, 130. In some embodiments, communication bus may deliver information and power to at least one well tool 110, 120, 130 simultaneously.

FIG. 5 shows a flow chart of a method 500 according to one embodiment of the present disclosure. In step 510, a power supply 310 may be energized. In step 520, power from the power supply 310 may be delivered along a communication bus 250 to at least one well tool 110, 120, 130. In step 530, the at least one well tool 110, 120, 130 may be operated using the power supplied over the communication bus 250. The communication interface 210, 220, 230 on each well tool 110, 120, 130 may be configured to receive power to operate the well tool 110, 120, 130. The communication interface 210, 220, 230 may use a multi-drop deterministic protocol. In some embodiments, the communication bus 250 may convey information and power simultaneously.

FIG. 6 is a schematic diagram of an exemplary drilling system 50 that includes a carrier 14, such as a drill string, having a downhole assembly 100 attached to its bottom end. FIG. 6 shows a drill string 14 that includes a downhole assembly 100 conveyed by a drill string 14 in a borehole 12. The drilling system 50 includes a conventional derrick 20 erected on a platform or floor 112 which supports a rotary table 114 that is rotated by a prime mover, such as an electric motor (not shown), at a desired rotational speed. The drill string 14, such as jointed drill pipe, having the downhole assembly 100, attached at its bottom end extends from the surface to the bottom 151 of the borehole 12. A drill bit 150, attached to downhole assembly 100, disintegrates the geological formations when it is rotated to drill the borehole 12. The drill string 14 may be rotated by a top drive (not shown) instead of by the prime mover and the rotary table 114. In some applications, the drill bit 150 is rotated by only rotating the drill string 14.

A surface control unit or controller 140 may receive signals from the downhole sensors and devices used in the system 50 and process such signals according to programmed instructions provided to the surface control unit 140. The surface control unit 140 displays desired drilling parameters and other information on a display/monitor 142 that is utilized by an operator to control the drilling operations. The surface control unit 140 may be a computer-based unit that may include a processor 147 (such as a microprocessor), a storage device 144, such as a solid-state memory, tape or hard disc, which may be configured to hold one or more computer programs that are accessible to the processor 147 for executing instructions contained in such programs. The surface control unit 140 may further communicate with a remote control unit (not shown) and/or a remote data processing unit (not shown). The surface control unit 140 may process data relating to the drilling operations, data from the sensors and devices on the surface, data received from downhole, and may control one or more operations of the downhole and surface devices. The data may be transmitted in analog or digital form.

The downhole assembly 100 may also contain formation evaluation sensors or devices (also referred to as measurement-while-drilling (“MWD”) or logging-while-drilling (“LWD”) sensors) determining resistivity, density, porosity, permeability, acoustic properties, nuclear-magnetic resonance properties, formation pressures, properties or characteristics of the fluids downhole and other desired properties of the earth formation 10 surrounding the drilling assembly 100. The downhole assembly 100 may further include a variety of well tools 110, 120, 130 such as sensors and devices for determining one or more properties of the downhole assembly 100 (such as vibration, bending moment, acceleration, oscillations, whirl, stick-slip, etc.) and drilling operating parameters, such as weight-on-bit, fluid flow rate, pressure, temperature, rate of penetration, azimuth, tool face, drill bit rotation, etc.)

The drilling system 50 may include a steering apparatus (not shown) for steering the drill bit 150 along a desired drilling path. In one aspect, the steering apparatus may include a steering unit (not shown), having a number of force application members (not shown), wherein the steering unit is at least partially integrated into the drilling motor. In another embodiment the steering apparatus may include a steering unit (not shown) having a bent sub and a first steering device (not shown) to orient the bent sub in the wellbore and the second steering device (not shown) to maintain the bent sub along a selected drilling direction.

The downhole assembly 100 may include sensors, circuitry and processing software and algorithms for providing information about desired dynamic drilling parameters relating to the downhole assembly, drill string, the drill bit and downhole equipment such as a drilling motor, steering unit, thrusters, etc. Exemplary sensors include, but are not limited to, drill bit sensors, an RPM sensor, a weight-on-bit sensor, sensors for measuring mud motor parameters (e.g., mud motor stator temperature, differential pressure across a mud motor, and fluid flow rate through a mud motor), and sensors for measuring acceleration, vibration, whirl, radial displacement, stick-slip, torque, shock, vibration, strain, stress, bending moment, bit bounce, axial thrust, friction, backward rotation, downhole assembly buckling and radial thrust. Sensors distributed along the drill string can measure physical quantities such as drill string acceleration and strain, internal pressures in the drill string bore, external pressure in the annulus, vibration, temperature, electrical and magnetic field intensities inside the drill string, bore of the drill string, etc.

The drilling system 50 may include one or more downhole processors on the downhole assembly 100. The processor(s) may include a microprocessor that uses a computer program implemented on a suitable machine readable medium that enables the processor to perform the control and processing. The machine readable medium may include ROMs, EPROMs, EAROMs, EEPROMs, Flash Memories, RAMs, Hard Drives and/or Optical disks. Other equipment such as power and data buses, power supplies, and the like will be apparent to one skilled in the art. In one embodiment, downhole assembly 100 may use mud pulse telemetry to communicate data from a downhole location to the surface while drilling operations take place. The surface processor 147 can process the surface measured data, along with the data transmitted from the downhole processor, to evaluate formation lithology.

While the foregoing disclosure is directed to the one mode embodiments of the disclosure, various modifications will be apparent to those skilled in the art. It is intended that all variations be embraced by the foregoing disclosure.

We claim:

1. An apparatus for communicating in a borehole, comprising:
a plurality of well tools configured to be disposed in the borehole;
a communication interface associated with each of the plurality of well tools, each of the communication interfaces being configured to use a multi-drop deterministic protocol; and
a communication bus in communication with the communication interfaces.

2. The apparatus of claim 1, wherein the multi-drop deterministic protocol includes an ARCNET protocol.

3. The apparatus of claim 1, wherein the communication bus includes at least one of: i) at least one conductor, ii) a twisted pair, iii) a coaxial cable, and iv) a fiber optic link.

4. The apparatus of claim 1, wherein the communication bus is configured to communicate using at least one of: i) electrical signals, ii) electromagnetic signals, and iii) optical pulses.

5. The apparatus of claim 1, further comprising:
a connector disposed between the communication bus and at least one of the plurality of well tools, the connector configured for a downhole environment.

6. The apparatus of claim 1, at least one of the plurality of communication interfaces being configured to deliver power to operate at least one of the plurality of well tools.

7. The apparatus of claim 6, further comprising:
a separator configured to at least partly separate a common mode from a differential mode between the at least one of the plurality of well tools and the communication bus.

8. The apparatus of claim 6, wherein the communication interface is further configured to deliver power and information to the at least one of the plurality of well tools simultaneously.

9. A method for communication in a borehole, comprising:
delivering information over an information network to at least one of a plurality of well tools disposed downhole, the information network using a multi-drop deterministic protocol.

10. The method of claim 9, wherein the multi-drop deterministic protocol includes an ARCNET protocol.

11. The method of claim 9, wherein the communication bus includes at least one of: i) a twisted pair, ii) a coaxial cable, and iii) a fiber optic link.

12. The method of claim 9, wherein the information network is configured to communicate using at least one of: i) electrical signals, ii) electromagnetic signals, and iii) optical pulses.

13. The method of claim 9, further comprising:
delivering power to operate the at least one of the plurality of well tools, wherein the power is delivered from the information network.

14. The method of claim 13, further comprising:
separating a common mode from a differential mode between the at least one of the plurality of well tools and the information network using a separator.

15. The method of claim 13, wherein the power and the information are delivered to the at least one of the plurality of well tools simultaneously.

16. An apparatus for delivering power, comprising:
an information network comprising:
a communication bus; and
a plurality of communication interfaces, each of the communication interfaces being associated with one of a plurality of well tools, wherein the plurality of communication interfaces use a multi-drop deterministic protocol, and the information network being configured to deliver electrical power over the multi-drop deterministic protocol to operate at least one of the plurality of well tools.

17. The apparatus of claim 16, wherein the multi-drop deterministic protocol includes an ARCNET protocol.

18. The apparatus of claim 16, further comprising:
a separator configured to separate a common mode and a differential mode between the at least one of the plurality of well tools and the communication bus.

19. The apparatus of claim 16, further comprising:
a connector disposed between the information network and at least one of the plurality of well tools, the connector configured for a downhole environment.

20. The apparatus of claim 16, the information network being configured to deliver information to at least one of the plurality of well tools simultaneously.
